(19) United States
(12) Patent Application Publication
(10) Pub. No.: US 2018/0266258 A1
(43) Pub. Date: Sep. 20, 2018

(54) Mower Blade Lock

(71) Applicant: Dwight Thacker, Lucas, KS (US)

(72) Inventor: Dwight Thacker, Lucas, KS (US)

(21) Appl. No.: 15/922,697

(22) Filed: Mar. 15, 2018

Related U.S. Application Data
(63) Continuation-in-part of application No. 29/639,307, filed on Mar. 5, 2018.
(60) Provisional application No. 62/472,075, filed on Mar. 16, 2017.

(51) Int. Cl. F01D 5/32

(52) U.S. Cl. CPC F01D 5/32; E05B 79/02

(57) ABSTRACT

A mower blade lock has a blade hook and a handling portion connected opposite each other along a connecting body. The blade hook attached to a lawnmower blade, while the handling portion may be grasped by the user or affixed to a deck or rim of the lawnmower

The current application is a continuation-in-part (CIP) application of the U.S. design application serial number 29/639,307 filed on Mar. 5, 2018.

The current application also claims a priority to a U.S. provisional application Ser. No. 62/472,075 filed on Mar. 16, 2017.

### FIELD OF THE INVENTION

The present invention relates generally to safety devices. More particularly, the present relates to a mower blade lock.

### BACKGROUND OF THE INVENTION

A lawn is an area of soil-covered land planted with grasses and other durable plants such as clover which are maintained at a short height with a lawnmower and used for aesthetic and recreational purposes. Common characteristics of a lawn are that it is composed only of grass species, it is subject to weed and pest control, it is subject to practices aimed at maintaining its green color (e.g., watering), and it is regularly mowed to ensure an acceptable length, although these characteristics are not binding as a definition. Lawns are used around houses, apartments, commercial buildings and offices. Many city parks also have large lawn areas. In recreational contexts, the specialized names turf, pitch, field or green may be used, depending on the sport and the continent.

The term “lawn”, referring to a managed grass space, dates to no earlier than the 16th century. Tied to suburban expansion and the creation of the household aesthetic, the lawn is an important aspect of the interaction between the natural environment and the constructed urban and suburban space. In many suburban areas, there are bylaws in place requiring houses to have lawns and requiring the proper maintenance of these lawns. In some jurisdictions where there are water shortages, local government authorities encourage alternatives to lawns to reduce water use.

A lawn mower, or mower, is a machine utilizing one or more revolving blades to cut a grass surface to an even height. The height of the cut grass may be fixed by the design of the mower, but generally is adjustable by the operator, typically by a single master lever, or by a lever or nut and bolt on each of the machine's wheels. The blades may be powered by muscle, with wheels mechanically connected to the cutting blades so that when the mower is pushed forward, the blades spin, or the machine may have a battery-powered or plug-in electric motor. The most common power source for lawn mowers is a small (typically one cylinder) internal combustion engine. Smaller mowers often lack any form of propulsion, requiring human power to move over a surface; “walk-behind” mowers are self-propelled, requiring a human only to walk behind and guide them. Larger lawn mowers are usually either self-propelled “walk-behind” types, or more often, are “ride-on” mowers, equipped so the operator can ride on the mower and control it.

It is occasionally desired or required to perform maintenance on lawn mowers, including such tasks as servicing or changing the blade or blades of the lawn mower. This can be a dangerous activity if the blade is not secured against rotating and potentially harming the user. In addition, various parts can fall during maintenance and cause damage to the user or other objects. It is therefore an objective of the present invention to present a blade lock for lawnmower blades which locks the blade in place for performing maintenance such as removing and replacing the blade or blades safely.

### BRIEF DESCRIPTION OF THE DRAWINGS

FIG. 1 is a side view of an embodiment of the present invention.

FIG. 2 is a side view of an embodiment of the present invention.

FIG. 3 is a perspective view of an embodiment of the present invention.

FIG. 4 is a side view of an embodiment of the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

The present invention is a blade lock for lawnmowers that may be affixed to the lawnmower blade in order to prevent the blade from rotation while performing maintenance operations on the lawn mower such as removing or replacing the blade.

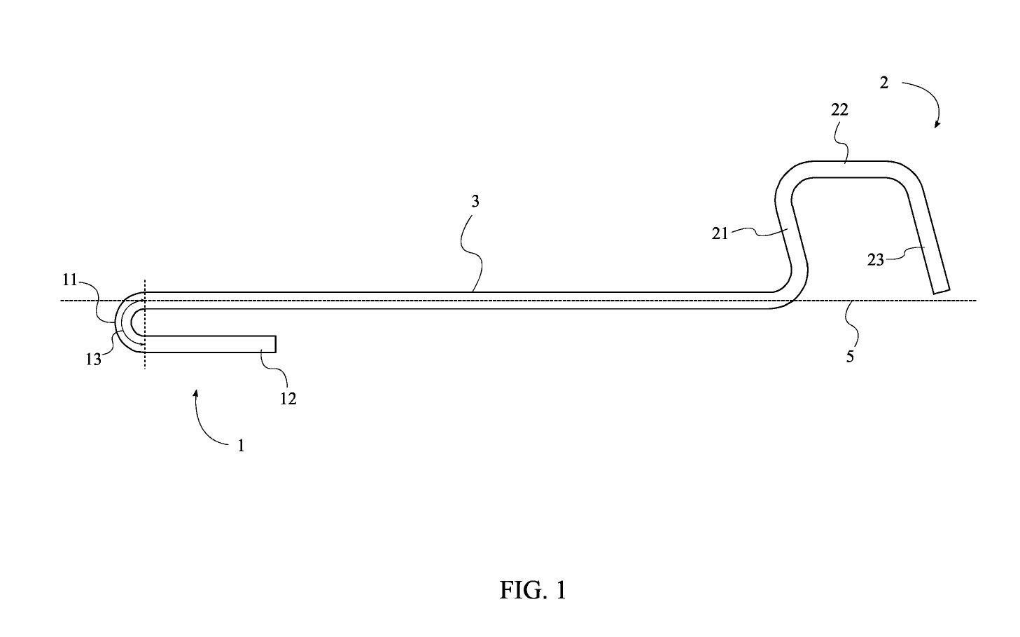

In general, referring to FIG. 1, the present invention comprises a blade hook 1, a handling portion 2, and a connecting body 3. The blade hook 1 is terminally connected adjacent to the connecting body 3, and the handling portion 2 is terminally connected adjacent to the connecting body 3 opposite the blade hook 1 along the connecting body 3. The blade hook 1 is affixed to the lawnmower blade during use. The handling portion 2 may be manually gripped by the user in order to manipulate the positioning of the present invention, and/or the handling portion 2 may be affixed to a deck or rim component of the lawnmower so that the blade is constrained against rotation. The present invention is preferably made of a strong material, such as, but not limited to, iron or steel. The present invention may be made of any material suitable for the disclosed purpose of the present invention.

In the preferred embodiment, the connecting body 3 is an elongated rod. In other embodiments, the connecting body 3 may vary in form and structure. In general, the connecting body 3 serves as a structural base connecting the blade hook 1 and the handling portion 2 together.

The blade hook 1 of the present invention is formed in order to hook over, latch onto, or otherwise grasp the lawnmower blade and prevent it from moving. In various embodiments, the blade hook 1 may comprise various forms which allow the blade hook 1 to achieve the aforementioned purpose. For example, in some embodiments, the blade hook 1 may comprise a latching mechanism securing the blade hook 1 to the lawnmower blade. However, in the preferred embodiment, the blade hook 1 is simply a generally U-shaped component, with the lawnmower blade being positioned within the crook of the U-shape when in use, and with the bottom of the U-shape representing the direction of rotation of the lawnmower blade to be prevented.

More particularly, in some embodiments, the blade hook 1 comprises a bend 11 and a terminal portion 12. The bend 11 is connected adjacent to the connecting body 3 and corresponds to the bottom of the aforementioned U-shape. The terminal portion 12 is connected adjacent to the bend 11 opposite the connecting body 3 along the bend 11, completing the U-shape. In some embodiments, the terminal portion 12 is oriented parallel to the connecting body 3 to ensure adequate capture of the lawnmower blade during use. To do so, in some embodiments the bend 11 comprises a bend 11 angle 13 greater than 90 degrees. More particularly, the bend 11 preferably comprises a bend 11 angle 13 greater than 90 degrees, such as, but not limited to, 180 degrees.

In general, the purpose of the handling portion 2 should be understood to be for controlling the position of the blade hook 1 through the connecting body 3. The handling portion 2 may be grasped by the user for maneuvering the present invention into place and may further be affixed to an additional component of the lawn mower such as a deck, rim or other object within reach of the lawnmower blade. As such, the handling portion 2 may also comprise a general hook shape or U-shape, though adapted for facilitating user grasp and being attached to the lawnmower deck. In some embodiments, the U-shape of the handling portion 2 and the U-shape of the blade hook 1 may be oriented at or near 90 degrees to each other.

Thus, in some embodiments, the handling portion 2 comprises a first portion 21, a second portion 22, and a third portion 23. The first portion 21 is angularly connected to the connecting body 3, the second portion 22 is angularly connected to the first portion 21 opposite the connecting body 3, and the third portion 23 is angularly connected to the second portion 22 opposite the first portion 21 and is oriented parallel to the first portion 21. Thus, the handling portion 2 may form a general U-shape, or a shape resembling a quadrilateral missing a side.

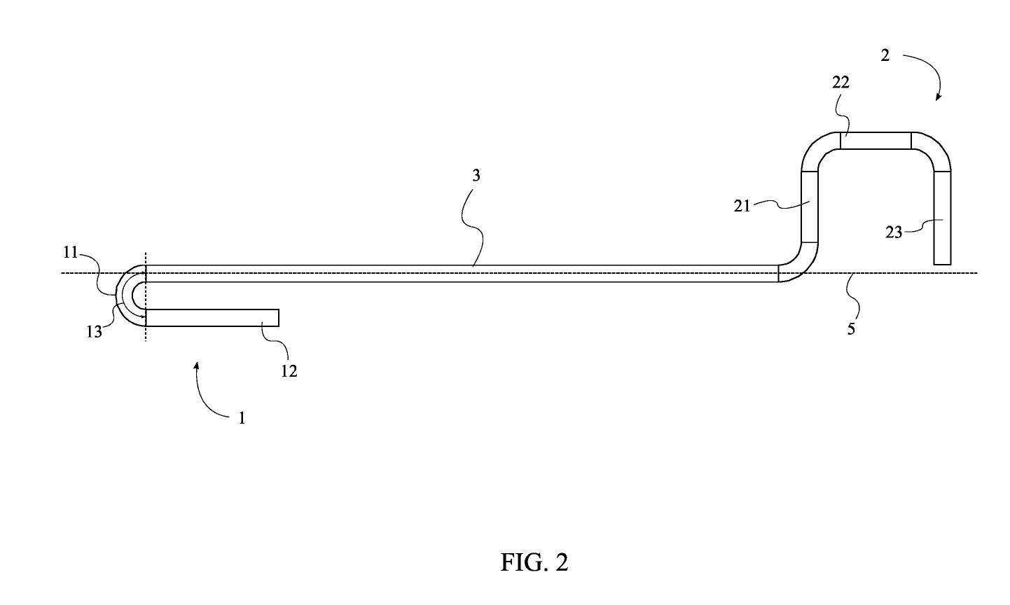

In some embodiments as illustrated in FIG. 2, the first portion 21 is perpendicularly connected to the connecting body 3, the second portion 22 is perpendicularly connected to the first portion 21, and the third portion 23 is perpendicularly connected to the second portion 22.

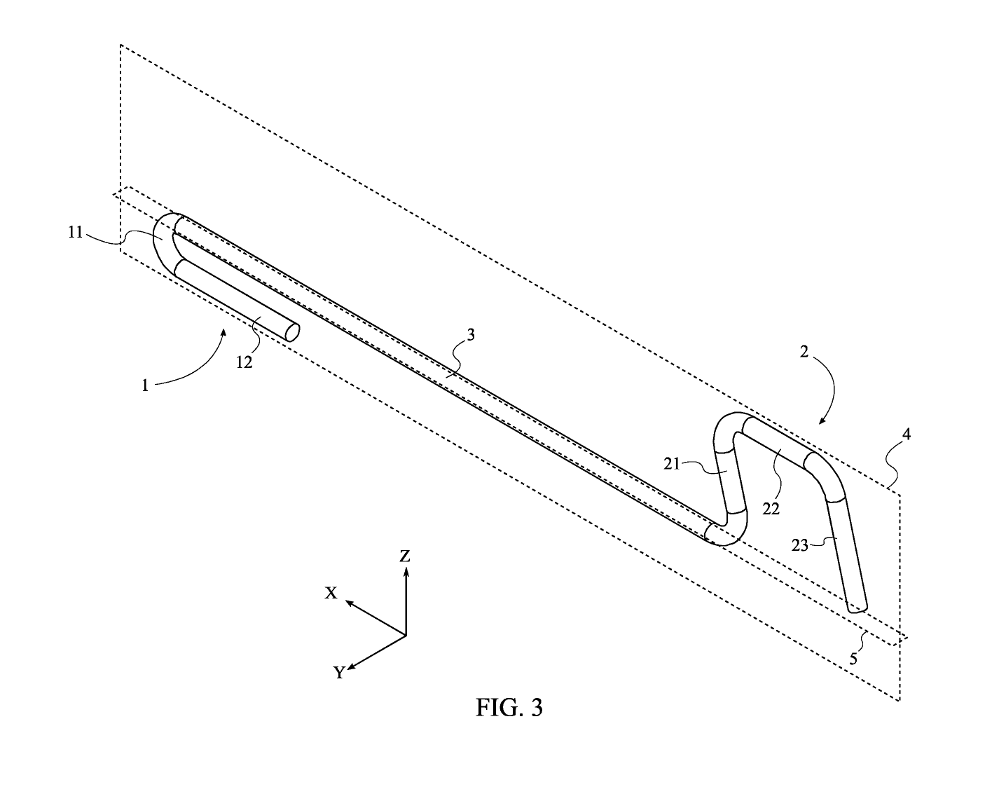

Referring to FIG. 3, in order to further define the present invention, a first reference plane 4 and a second reference plane 5 are defined, with the first reference plane 4 being oriented perpendicular to the second reference plane 5. In the preferred embodiment, the blade hook 1, the connecting body 3, and the handling portion 2 are oriented parallel to the first reference plane 4, and the connecting body 3 is oriented parallel to the second reference plane 5. More particularly, here an X dimension is defined as parallel to the connecting body 3, a Y dimension is defined perpendicular to the X dimension, and a Z dimension is defined as perpendicular to the X dimension and the Y dimension, wherein the blade hook 1 and the handling portion 2 extend away from the connecting body 3 in the Z dimension. The first reference plane 4 is oriented along the X dimension and the Z dimension, while the second reference plane 5 is oriented along the X dimension and the Y dimension.

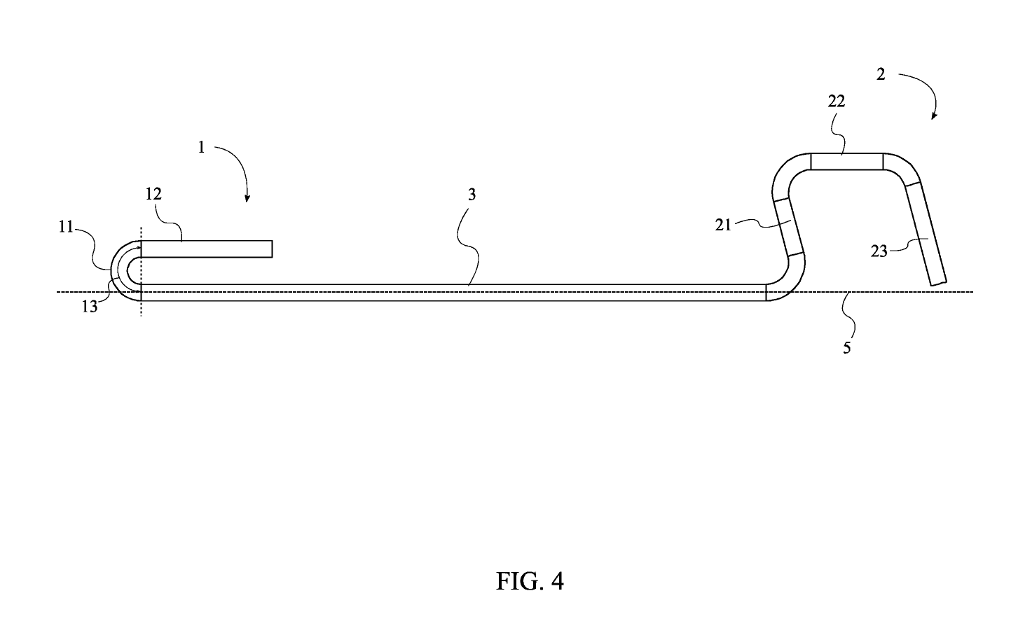

In some embodiments, the handling portion 2 and the blade hook 1 are positioned opposite each other about the second reference plane 5, as shown in FIGS. 1-3. In some embodiments, the handling portion 2 and the blade hook 1 may be positioned on the same side of the second reference plane 5, as shown in FIG. 4.

In view of the foregoing disclosure, the present invention is made to hold the mower blade while removing and replacing the mower blade. The present invention locks on the blade and holds onto the outside of the deck. The present invention prevents the parts from falling out and promotes safety.

The present invention is used to remove and replace mower blades. The user utilizes the present invention to hook over the blade and side of the deck. One side of the present invention is to remove while the other side of the present invention is to replace. The present invention holds the blade while loosening nuts or bolts on the bottom of the blades.

Although the invention has been explained in relation to its preferred embodiment, it is to be understood that many other possible modifications and variations can be made without departing from the spirit and scope of the invention as hereinafter claimed.

What is claimed is:

1. A mower blade lock comprises:
a blade hook;
a handling portion;
a connecting body;
the blade hook being terminally connected adjacent to the connecting body; and
the handling portion being terminally connected adjacent to the connecting body opposite the blade hook along the connecting body.

2. The mower blade lock as claimed in claim 1, wherein the connecting body is an elongated rod.

3. The mower blade lock as claimed in claim 1 comprises:
the blade hook comprises a bend and a terminal portion;
the bend being connected adjacent to the connecting body; and
the terminal portion being connected adjacent to the bend opposite the connecting body along the bend.

4. The mower blade lock as claimed in claim 3 comprises:
the terminal portion being oriented parallel to the connecting body.

5. The mower blade lock as claimed in claim 3 comprises:
the bend comprises a bend angle greater than 90 degrees.

6. The mower blade lock as claimed in claim 3 comprises:
the bend comprises a bend angle of 180 degrees.

7. The mower blade lock as claimed in claim 1 comprises:
the handling portion comprises a first portion, a second portion, and a third portion;
the first portion being angularly connected to the connecting body;
the second portion being angularly connected to the first portion opposite the connecting body; and
the third portion being angularly connected to the second portion opposite the first portion.

8. The mower blade lock as claimed in claim 7 comprises:
the third portion being oriented parallel to the first portion.

9. The mower blade lock as claimed in claim 1 comprises:
the handling portion comprises a first portion, a second portion, and a third portion;
the first portion being perpendicularly connected to the connecting body;
the second portion being perpendicularly connected to the first portion opposite the connecting body; and
the third portion being perpendicularly connected to the second portion opposite the first portion.

10. The mower blade lock as claimed in claim 1 comprises:
a first reference plane;
a second reference plane;
the first reference plane being oriented perpendicular to the second reference plane;
the blade hook, the connecting body, and the handling portion being oriented parallel to the first reference plane; and
the connecting body being oriented parallel to the second reference plane.

11. The mower blade lock as claimed in claim 10 comprises:
the handling portion and the blade hook being positioned opposite each other about the second reference plane.

12. A mower blade lock comprises:
a blade hook;
a handling portion;
a connecting body;
the blade hook being terminally connected adjacent to the connecting body;
the handling portion being terminally connected adjacent to the connecting body opposite the blade hook along the connecting body;
the connecting body being an elongated rod;
the handling portion comprises a first portion, a second portion, and a third portion;
the first portion being angularly connected to the connecting body;
the second portion being angularly connected to the first portion opposite the connecting body; and
the third portion being angularly connected to the second portion opposite the first portion.

13. The mower blade lock as claimed in claim 12 comprises:
the blade hook comprises a bend and a terminal portion;
the bend being connected adjacent to the connecting body; and
the terminal portion being connected adjacent to the bend opposite the connecting body along the bend.

14. The mower blade lock as claimed in claim 13 comprises:
the terminal portion being oriented parallel to the connecting body.

15. The mower blade lock as claimed in claim 13 comprises:
the bend comprises a bend angle greater than 90 degrees.

16. The mower blade lock as claimed in claim 13 comprises:
the bend comprises a bend angle of 180 degrees.

17. The mower blade lock as claimed in claim 12 comprises:
the third portion being oriented parallel to the first portion.

18. The mower blade lock as claimed in claim 12 comprises:
the handling portion comprises a first portion, a second portion, and a third portion;
the first portion being perpendicularly connected to the connecting body;
the second portion being perpendicularly connected to the first portion opposite the connecting body; and
the third portion being perpendicularly connected to the second portion opposite the first portion.

19. The mower blade lock as claimed in claim 12 comprises:
a first reference plane;
a second reference plane;
the first reference plane being oriented perpendicular to the second reference plane;
the blade hook, the connecting body, and the handling portion being oriented parallel to the first reference plane; and
the connecting body being oriented parallel to the second reference plane.

20. The mower blade lock as claimed in claim 19 comprises:
the handling portion and the blade hook being positioned opposite each other about the second reference plane.
